(19) United States
(12) Patent Application Publication
(10) Pub. No.: US 2002/0100655 A1
(43) Pub. Date: Aug. 1, 2002

(54) Synchronizing mechanism with asymetric toothing

(76) Inventors: Jens Patzner, Potsdam (DE); Wolfgang Bernau, Brandenburg (DE); Dirk Blechschmidt, Brandenburg (DE); Kurt Bathe, Brandenburg (DE)

Correspondence Address: DAVIS & BUJOLD, P.L.L.C., 500 NORTH COMMERCIAL STREET, FOURTH FLOOR, MANCHESTER, NH, 03101, US

(21) Appl. No.: 10/052,028

(22) Filed: Jan. 18, 2002

(30) Foreign Application Priority Data
Jan. 26, 2001 (DE) 101 03 423.7

(51) Int. Cl. F16D 23/04

(52) U.S. Cl. 192/53.1; 192/53.34; 192/69; 192/108

(57) ABSTRACT

The synchronizing mechanism for shift clutch of mechanical transmissions in motor vehicles has one sliding sleeve with meshing teeth and one clutch with meshing teeth. The half angles a₁, a₂; b₁, b₂ of the ridge edges 5, 5′; 6, 6′ and the ridge edges of the meshing teeth of the sliding sleeve and of the clutch are disposed asymmetrically relative to the respective tooth central axes 3, 3′; 4, 4′.

According to the preamble of claim 1 the invention concerns a synchronizing mechanism.

Synchronizing mechanisms for mechanical transmissions of motor vehicles have a sliding sleeve non-rotatably connectable, by axial displacement, with a shaft and provided with inner teeth, a clutch provided with outer teeth and a synchronizer ring which is positively connected, in a peripheral direction, via outer teeth with the sliding sleeve and frictionally connected with the clutch. The teeth of the synchronizer ring has locking faces forming an angle with each other for engaging in corresponding locking faces of the teeth of the sliding sleeve.

Such synchronizing mechanisms are widely known and have been described, for ex., in German Patent No. 26 59 448. If a gear is introduced from the neutral position by displacing the sliding sleeve in axial direction, the latter takes along the synchronizing ring and presses it at the same time against an inverse cone of the clutch. A frictional connection is thereby created between synchronizer ring and clutch by means of which is achieved a rotational speed adjustment between the shaft, the sliding sleeve and the synchronizer ring, the same is achieved by the clutch and the appertaining gear wheel of the pair of wheels to be engaged. Locking faces provided on the synchronizer ring are here brought to a position in which they come to engagement on the sliding sleeve with the appertaining and adapted locking faces and thereby prevent axial displacement of the sliding sleeve in direction to the clutch. The locking faces are usually mounted on outer teeth of the synchronizer ring adapted to the outer teeth of the clutch, the counterfaces are here mounted at the ends of the teeth which form the inner teeth of the sliding sleeve. Not until reaching the synchronous rotational speed can the sliding sleeve be inserted past the locking faces of the synchronizer ring of the outer teeth of the clutch.

During an upshift of the transmission, that is, when a higher gear is introduced, the gear wheel coaxial with the sliding sleeve and to which the connection is created, during the upshift, at first, runs quicker than the sliding sleeve so that it usually has to be decelerated via the synchronizer ring to reach a synchronous speed. But if strong braking forces appear upon the transmission, for ex., as consequence of a greater viscosity of the transmission oil when the transmission is cold, the wheel set is decelerated after disengagement of the lower gear by braking forces whereby the transmission rotational speed, during engagement of the higher gear, can drop to the extent that a synchronous speed is generated between the sliding sleeve and the clutch and the sliding sleeve glides past the locking faces on the synchronizer ring without a frictional connection being produced between the synchronizer ring and the clutch. Owing to this braking effect and further reduction of the rotational speed of the gear wheel coaxial with the sliding sleeve, it is possible to arrive at a so-called cold scratch which is felt as disagreeable.

To prevent this unpleasant noise, German Patent No. 34 44 670 describes a synchronizing mechanism for separating clutches of mechanical transmission of a motor vehicles which has at least one pair of wheels whose gear wheel is coaxial with a sliding sleeve non-rotatably connected with a shaft via a synchronizer body and having inner teeth, it can be connected and disconnected in the power flow and it also has a synchronizer ring which in peripheral direction, is positively connected with the sliding sleeve and frictionally connected with the clutch and which has locking faces for the sliding sleeve which each prevent relative torsion between the clutch and the sliding sleeve, in the end position defined by a positive connection between the synchronizer ring and the sliding sleeve, an engagement of the inner teeth of the sliding sleeve in the outer teeth of the clutch and allow it only upon reaching the synchronous rotational speed sided by torsion of synchronizer ring and clutch. The locking faces on the sliding sleeve which, in the moving direction, are in front here have greater axial length than the locking faces which in the moving direction are at the rear. The outer teeth of the clutch, the same as the locking faces of the sliding sleeve, are asymmetrically designed, but in such manner that even though having the same inclination relative to the axial direction, they are offset relative to the longitudinal center of each tooth so that the two bearing faces belonging to one tooth have different axial lengths and thus faces of different size, the locking faces on the sliding sleeve that are in front in moving direction have the greater length compared with the locking faces that are in the rear in moving direction.

By using a defined asymmetry in the ridge of the locking teeth of the sliding sleeve, the effect obtained is reinforced so that during an upshift, after the end of the synchronous operation, the synchronizer ring enters into a downshift locking position before the sliding sleeve with its downshift locking edge has moved past in axial direction on the down shift locking edge of the synchronizer ring. The downshift locking position is the position on the opposite torsion stop while the downshift locking face is the length of the two locking faces on the sliding sleeve. After release from said downshift locking position, the shifting operation can be terminated without a meshing scratch. But because of the above described asymmetry there occurs, on the release phase after an upshift, when the synchronizing ring enters in the downshift locking position, a power pulse on the sliding sleeve which is to be clearly perceived as an impact on the shift lever.

In order to prevent the power pulse upon the sliding sleeve and thus preclude the impact acting upon the shift lever, in the Applicant's DE-A 100 22 509 is described a synchronizing mechanism for separating clutches of mechanical transmission for motor vehicles having at least one pair of wheels whose gear wheel coaxial with a sliding sleeve has a clutch with outer teeth which, by axial displacement of the sliding sleeve non-rotatably connected with a shaft via a synchronizer body and having inner teeth can be connected and disconnected in the power flow. The locking faces of the teeth of the sliding sleeve which are in front, in the moving direction, have a smaller axial length than the locking faces that are in the rear, in the moving direction. An asymmetry in the ridge of the locking toothing of the sliding sleeve makes possible that the effect of the entrance in the downshift locking position is prevented so that the power impact on the shift lever does not occur.

In order to prevent in a synchronized toothed wheel change transmission the occurrence of upshift scratches without impairing the transmission capacity of the synchronizing mechanism, DE-C 19646850 has disclosed a synchronizing mechanism of a toothed wheel change transmission which has a shift sliding sleeve with axial clutch teeth having a group of clutch teeth with sloping faces used exclusively as locking faces and a group of clutch teeth with sloping faces used exclusively for meshing with a corresponding axial clutch teeth of the gear wheel. The locking teeth are interrupted in a peripheral direction to the central axis by a recess without teeth, the sloping faces belonging to the second group of clutch teeth and exclusively used for meshing being placed opposite in relation to the directions of the central axis while the sloping faces of the first group of clutch teeth exclusively used for locking can each be brought in opposite contact exclusively with one sloping face designed in one piece with the front end remote form the gear wheel of a locking tooth of the locking teeth.

Therefore, in these modern manual mechanical transmissions, separate teeth are used for the functions of locking and meshing in order to improve the comfort when shifting. The respective half angles can be designed symmetrically or asymmetrically. In the meshing teeth, a symmetrical design results in that, depending on the impingement of the meshing teeth of the sliding sleeve upon the tooth side of the corresponding clutch teeth, that is either remote from or facing the acting power loss, different forces are required to implement the meshing operation; said impingement upon one of the two tooth sides is purely an accidental occurrence.

he problem on which this invention is based is to provide a synchronizing mechanism with which said different energy consumption when meshing is minimized or prevented and the energy consumption is reduced to a lower level of substantially equal size.

This problem is solved by the features stated in the characteristic part of claim 1.

With the inventive development of the meshing teeth of the sliding sleeve and of the clutch an improvement in shifting comfort is made possible over the total number of shifting operations, the frequency of the impinging of the meshing teeth of the sliding sleeve upon the tooth side of the clutch teeth facing the acting power loss are considerably reduced, at the same time, the axially acting shifting force required in the presence of a counteracting power loss being clearly less so that the differences in the meshing course between shifting operations, in a direction of the power loss and shifting operations contrary to the action of the power loss are smaller.

The invention is explained in detail herebelow with reference to the drawing where are diagrammatically shown the inventively designed meshing teeth of the clutch and of the sliding sleeve.

The expert is well acquainted with synchronizing mechanisms for mechanical transmissions of motor vehicles so that only the parts needed for an understanding of the invention are shown in the drawings and described herebelow. The same parts bear the same reference numerals in the figures, there being shown, in all three figures, a developed respective section through two teeth.

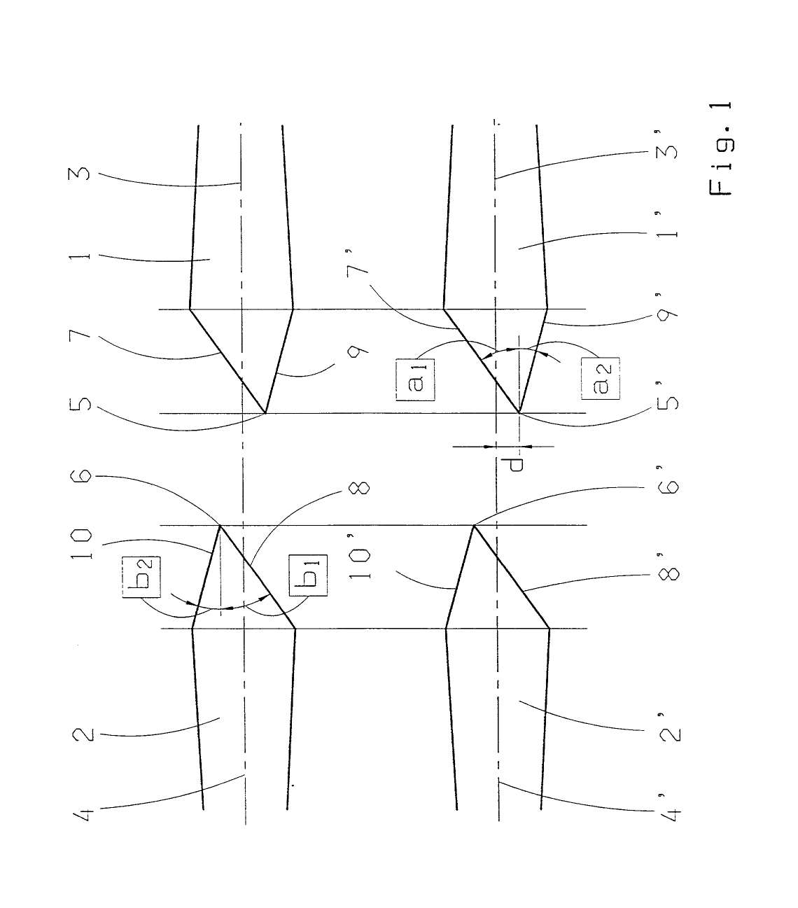

With 1, 1′ are designated two teeth of the sliding sleeve and with 2, 2′ two teeth of the clutch. According to FIG. 1 the half angles a₁, a₂; b₁, b₂ of the teeth of the meshing teeth are asymmetrical relative to each other and the ridge edges 5, 5′ 6, 6′ of the sliding sleeve and of the clutch are also asymmetrically disposed relative to respective central axes 3, 3′, 4, 4′ of the teeth.

The asymmetry of the half angles a₁, a₂; b₁, b₂ of the meshing teeth of sliding sleeve and clutch results, throughout the number of shifting operations, in a uniform meshing course relative to a power consumption and time so that in case of shifting operations with meshing against the action of the power loss Mv, the axially acting shifting force required in a counteracting power loss clearly becomes lower and thus the differences in meshing course between shifting operations, in a direction of the power loss effect and shifting operations against the direction of the power loss effect, become smaller.

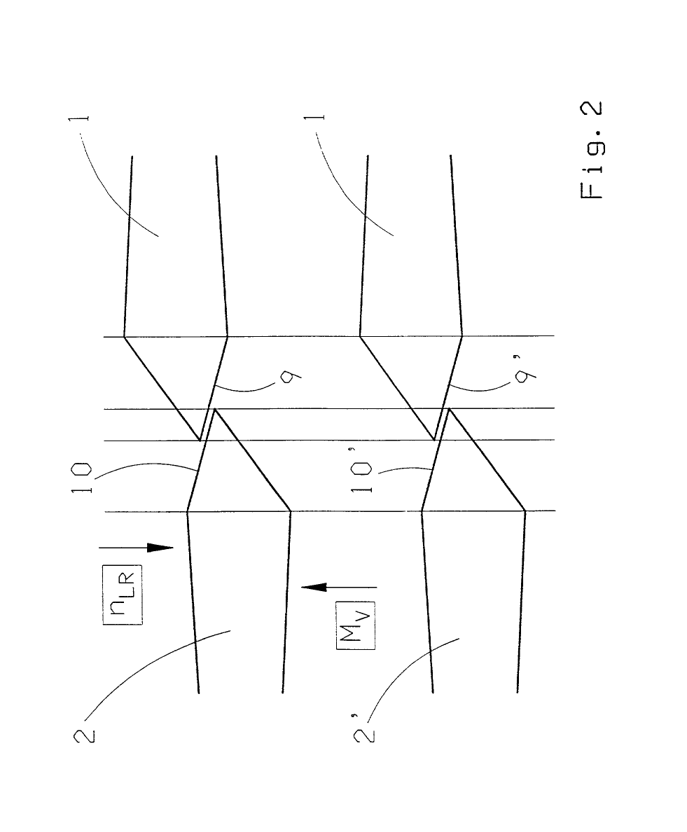

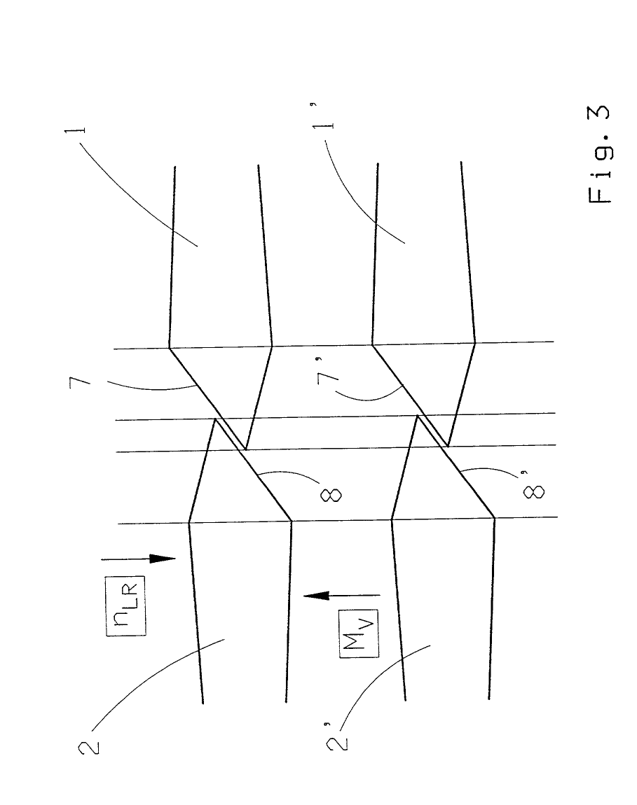

The asymmetry of the arrangement of the ridge edges 5, 5′; 6, 6′ relative to the appertaining tooth central axes 3, 3′, 4, 4′ and relative to each other is selected so that the length of the tooth flanks 9, 9′; 10, 10′, in a peripheral direction, which mesh opposite to the direction of the acting power loss Mv (FIG. 2) be smaller than the length of the tooth flanks 7, 7′; 8, 8′ (FIG. 3), in a peripheral direction, which mesh with the direction of the power loss. This step reduces the probability of impingement of the meshing flanks when meshing against the action of the power loss so that the comfort when shifting is considerably improved over the total number of shifting operations.

From the drawing and the above description it results that the half angle a₂ (angle of pressure contrary to the direction of the acting power loss Mv) is smaller than the half angle a₁ (angle of pressure in the direction of the acting power loss Mv) and that the half angle b₂ (angle of pressure contrary to the direction of the acting power loss Mv) is smaller than the half angle b₁ (angle of pressure in the direction of the acting power loss Mv).

FIG. 1 shows a diagrammatical representation of the meshing teeth of a sliding sleeve and a clutch body,

FIG. 2 shows the meshing operation contrary to the direction of the power loss effect, and

FIG. 3 shows the meshing operation in the direction of the power loss effect Mv, the power loss acting upon the idle wheel with the clutch.

The arrow designated with n_{LR} indicates the direction of rotation of the idle wheel with the clutch.

### Reference Numerals

1 tooth 7 meshing side

2 tooth 8 meshing side

3 tooth central axis 9 meshing side

4 tooth central axis 10 meshing side

5 ridge edge a₁, a₂ half angle

6 ridge edge b₁, b₂ half angle

1. Synchronizing mechanism for shift clutches of motor vehicles having at least one gear wheel which is coaxial with a sliding sleeve and has a clutch with outer toothing and, by axial displacement of the sliding sleeve non-turnably connected with a shaft via a synchronizing body and having an inner toothing, can be connected or disconnected in the power flow, and having a synchronizer ring which in peripheral direction is positively connected with said sliding sleeve and frictionally connected with said clutch, said sliding sleeve and said clutch being provided with meshing teeth, characterized in that the half angles a₁, a₂; b,, b₂ of the ridge edges 5, 5′; 6, 6′ of said meshing teeth of said sliding sleeve and of said clutch are asymmetrical relative to each other and that said ridge edges 5, 5, 6, 6′ of said meshing teeth of said sliding sleeve and of said clutch are disposed asymmetrically relative to the respective tooth central axes 3, 3′, 4, 4′.

2. Synchronizing mechanism according to claim 1, characterized in that the asymmetrical arrangement of said ridge edges 5, 5′, 6, 6′ relative to said tooth central axes 3, 3′, 4, 4′ is selected so that the expansion in peripheral direction of the meshing flanks 9, 9′ 10, 10′ which mesh opposite to the direction of the meshing flanks 7, 7′, 8, 8′ which mesh in direction to the acting power loss Mv.

3. Synchronizing mechanism according to claim 1, characterized in that the half angles a1 and b1 as the angles of pressure in direction of the acting power loss Mv.
